(19) United States
(12) Patent Application Publication
(10) Pub. No.: US 2007/0136651 A1
(43) Pub. Date: Jun. 14, 2007

(54) Repurposing system

(76) Inventor: Glen W. Probst, Orem, UT (US)

Correspondence Address: STEVEN L. NICHOLS;RADER, FISHMAN & GRAVER PLLC, 10653 S. RIVER FRONT PARKWAY, SUITE 150, SOUTH JORDAN, UT, 84095, US

(21) Appl. No.: 11/298,441

(22) Filed: Dec. 9, 2005

(51) Int. Cl. G06F 15/00

(52) U.S. Cl. 715/500.1

(57) ABSTRACT

In one of many possible embodiments, a repurposing system is provided which includes an author mode configured to repurpose a plurality of media elements by partnering at least one media element with at least one repurposing element to form repurposed media content; and a player mode configured to display the repurposed media content; the system being configured to allow an authorized user to toggle between the author mode and the player mode while the author is partnering the media element.

### TECHNICAL FIELD

The present disclosure relates to systems for repurposing media, such as audio/visual works including without limitation, motion pictures, HTML content, audio, pictures, and the like for instruction in language learning and/or any subject-matter content learning education.

### BACKGROUND

Television, cinema, and other types of media provide a vast array of available programming. By watching a television broadcast or attending a film showing, a viewer can experience almost any type of video programming desired. Additionally, in order to make such video programming even more accessible to viewers, such video programming may be recorded on such media as video cassettes, including, but not limited to, any digital or analog media, including Blu-Ray and HDDVD, as well as hard drives, portable hard drives, flash/jump, thumb and pocket drives; zip disks, laser disc, CD-ROM, DVD, micro chips, or optical discs for playback using an appropriate recording and playback device at the viewer's convenience.

Being able to play back a repurposed, recorded video/motion picture program also provides the viewer with great control over how that program is viewed. For example, if a viewer wishes to replay a portion of the video program, he or she may do so using the playback device. Similarly, if the viewer wishes to skip over a portion of the video program, he or she may fast forward through the program using the playback device.

If the video programming is on an optical disc, such as a CD-ROM, laser disc, or a DVD, the reader of the playback device can quickly access any portion of the video program. If the optical disc playback device is incorporated into a computer, for example, and controlled by the computer, the user may specify what portion of the video program and what order those portions should be played by the playback device.

Recent efforts have been directed towards using computers to provide interactive exercises with motion pictures to create educational language learning and/or any subject-matter content learning computer program. Such programs are frequently difficult and tedious to program, requiring extensive interaction between multiple entities in order to fine tune or otherwise modify the programs.

### SUMMARY

In one of many possible embodiments, a repurposing system is provided which includes an author mode configured to repurpose a plurality of media elements by partnering at least one media element with at least one repurposing element to form repurposed media content; and a player mode configured to display the repurposed media content; the system being configured to allow an authorized user to toggle between the author mode and the player mode while the author is partnering the media element.

### BRIEF DESCRIPTION OF THE DRAWINGS

The accompanying drawings illustrate various embodiments of the present system and method and are a part of the specification. The illustrated embodiments are merely examples of the present system and method and do not limit the scope of the disclosure.

FIG. 1 illustrates a schematic view of a repurposing system according to one exemplary embodiment.

FIG. 2 illustrates scene selection and repurposing according to one exemplary embodiment.

Throughout the drawings, identical reference numbers designate similar, but not necessarily identical, elements.

### DETAILED DESCRIPTION

A system and method is described herein for use in language learning and/or any subject-matter content learning education, such as to teach a foreign or second language or specific content in any language. In particular, according to one exemplary embodiment, a system includes an author mode and a player mode. The author mode allows an educator or other author to annotate and/or repurpose the media content as desired. The media content may include any number of files or clips selected from a media work or from a library. Other repurposing elements may then be added to the time line of the clips including, without limitation, vocabulary lists, exercises, or other learning activities or aids that the author selects and associates with corresponding portions along the time line of the clip. Thus, the system allows an author to repurpose and/or annotate media content.

While in player mode, the present exemplary system allows the repurposed media content programmed by the author to be viewed with a similar appearance as it would be if viewed by a student. In such a mode, the repurposed media content remains in the form designated by the author to be viewed by the student. As such, while in player mode, the repurposed media content is not typically modifiable. The system allows the author to toggle between the author mode and the player mode. Toggling between modes may allow the author to accurately view the content as viewed by a student, and to return to author mode to make any desired adjustments or changes. However, a student or user with access only to the player mode is generally unable to toggle to author mode.

In the following description, for purposes of explanation, numerous specific details are set forth in order to provide a thorough understanding of the present method and apparatus. It will be apparent, however, to one skilled in the art that the present method and apparatus may be practiced without these specific details. Reference in the specification to “one embodiment” or “an embodiment” means that a particular feature, structure, or characteristic described in connection with the embodiment is included in at least one embodiment. The appearance of the phrase “in one embodiment” in various places in the specification are not necessarily all referring to the same embodiment.

Repurposing System

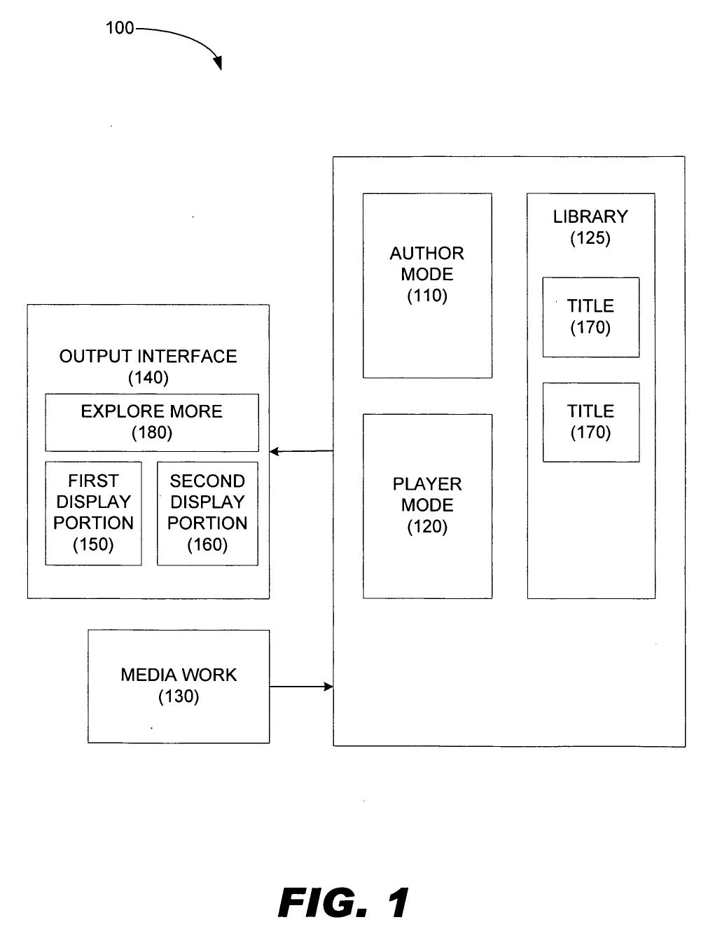

FIG. 1 illustrates a schematic view of a repurposing system (100) according to one exemplary embodiment. As shown in FIG. 1, the system (100) includes an author mode (110) and a player mode (120). The author mode (110) allows a user to modify and add content to one or more libraries (125) of repurposed media content. The separate player mode (120) allows another user to view this content. For ease of illustration, a single library (125) will be referenced in discussing the present system (100), however, those of skill in the art will appreciate that any number of libraries may be referenced by the system. Further, for ease of reference, a user authorized to modify and/or add content to the library (125) will hereinafter be referred to as an “author.” A user not authorized to modify and/or add content to the library will hereinafter be referred to as a “student.” According to one exemplary embodiment, the system (100) allows the author flexibility in repurposing media for use in such applications as language learning and/or any subject-matter content learning education, as will be described in further detail below.

As introduced, the author mode (110) allows the author to modify and/or add content to the library (125). In particular, the author mode (110) allows a user to repurpose media, such as a media work (130). Repurposed media includes at least two elements, including one or more portions of the media work (130) and at least one repurposing element.

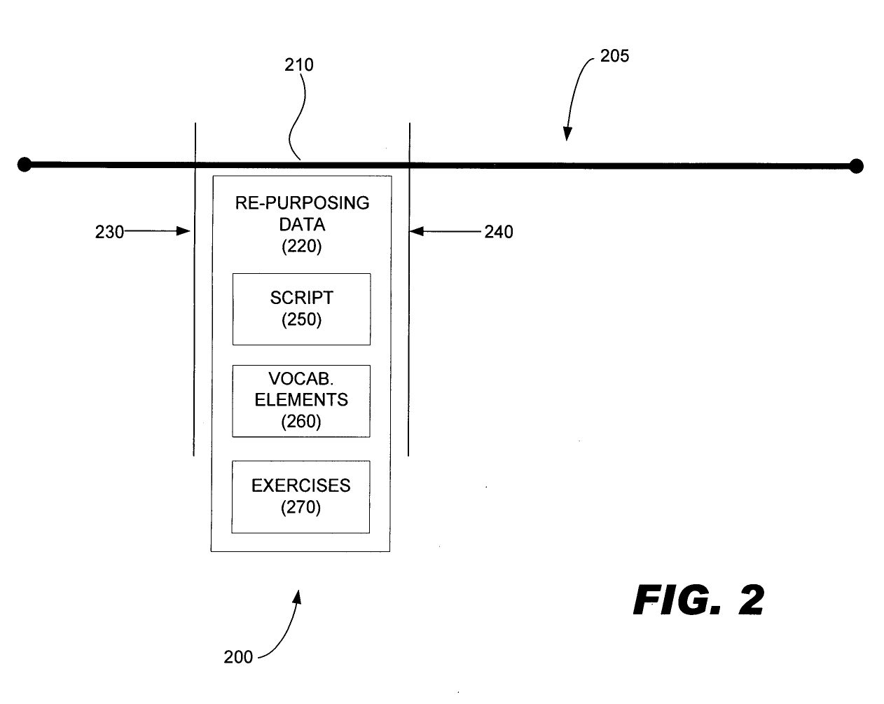

The media work (130) may include any type of media. For example, suitable types of media may include, without limitation, audio/visual works such as movies, television shows and the like; Internet content, music, pictures, or any other type of media. For ease of reference, the media work (130) will be discussed with reference to the content typically contained in a motion picture, such as that residing on a DVD. Thus, according to one exemplary embodiment, the system (100) is coupled to a media player, such as a DVD drive, configured to read the media work (130). The selection of the portions of the media work (130) will be discussed in more detail with reference to FIG. 2.

To repurpose the media work (130), the author may first view the media work (130) to be repurposed. The author may then select one or more portions of the media work (130) to repurpose. Thereafter, the author selects one or more repurposing elements to associate with desired portions of the media work (130). Associating a media element with a repurposing element may be generally referred to as partnering. Partnering the elements allows an author to join any two elements for display at the same time. For example, according to one exemplary embodiment discussed in more detail below, a portion of an audio visual work may be partnered with a textual element, such as a script.

To partner elements, an author uses the author mode (110) to select at least one media element and at least one repurposing element. The selected portions of the media work (130) may be saved to the library or a file may be created that includes the correspondence between the selected portions of the media work and the repurposing elements. In either case, the elements are displayed on an output interface (140). In particular, one element is displayed in a first display portion (150) while a second element is displayed in a second display portion (160), and so forth as desired. The author is able to modify each of the elements while they are simultaneously displayed. In the case of the example discussed above, the duration or other parameters of the scene may be modified and/or the text of the script may be modified. At some point during the repurposing of the media work, it may be desirable for the author to view the repurposed content as it would be viewed by the student.

For example, according to one exemplary embodiment, the repurposed content residing in the library may be viewed in player mode (120). In particular, player mode (120) may be accessed by the author (120) while the author is repurposing the work. Thus, the author is able to toggle between the author mode (110) and the player mode (120) while the author is repurposing the media work (130). Further, the player mode (120) may be accessed by another viewer after the repurposed work is complete. In particular, a student may be able to view the completed work after the author is through with repurposing.

In either case, while in player mode (120), when one element is selected, that element is displayed on the output interface (140). Additionally, any partnered element associated with the selected element is automatically selected and the selected element and the partnered element are simultaneously displayed.

As introduced, the content residing in the library (125) includes objects or elements organized hierarchically and/or relationally. A collection of elements related to a single media work (130) may be referred to as a title (170). Several titles (170) may reside in the library. Each title (170) includes one or more scenes (200, FIG. 2). Each scene includes a plurality of elements. Each element has a textual name and description, set by the author and visible to the student. In addition, each element has an icon. By default, this icon represents the type of the object. For example, a video element may have an icon representing frames of a movie, while a textual element may have a block letter icon associated therewith. Any icon selection can be subsequently overridden by the author. In particular, the author may choose to associate any icon with any element. The icons may be included as templates or may be selected from any other source. The creation of a scene, with several exemplary elements, will now be discussed in more detail.

Scene Formation

As introduced, the system allows the author to partner any number of media elements with any number of repurposing elements to create repurposed media content. One type of repurposed media content is described as a scene. The system allows an author substantial flexibility in repurposing media content, as will now be discussed in more detail. FIG. 2 illustrates a scene (200). The media work (130; FIG. 1) includes a timeline (205).

With user input devices, such as a keyboard and/or a mouse, the author is able to divide the timeline (205) into any number of segments. Each of these segments may be referred to as a clip (210). The scene (200) includes the clip (210) partnered with repurposing data (220). The repurposing data (220) repurposes the clip (210) to allow for expanded educational opportunities from the clip (210). As previously discussed, the clip (210) may be saved to the library or a file may be created that includes the correspondence between the selected portions of the time line (205) and the repurposing data (220). The selection of the clip (210) will first be discussed, followed by a discussion of the associated repurposing data.

According to one exemplary embodiment, the clip (210) is a selected portion of the media work (130). As seen in FIG. 2, the clip (210) may be selected by establishing a beginning (230) and an end (240) for the clip (210). According to one exemplary embodiment, while in author mode (110; FIG. 1), the system (100; FIG. 1) displays the media work (130) and the timeline (205) simultaneously. In particular, the timeline (205) includes individual frames that make up the media work. The frames may be numbered sequentially from the beginning of the media work as recorded. The author is able to select which portion of the media work (130) is displayed, such as by using fast-forward, reverse, or other commonly known navigational functions. When the desired point on the timeline (205) is reached, the author is able to select the beginning of the scene (200).

For example, a “grab beginning” icon may be displayed with the timeline (205). According to such an embodiment, the author selects, or grabs, the beginning of the clip by clicking on the grab beginning icon. The system (100; FIG. 1) then notes the frame number corresponding to the beginning (230) of the selected clip (210). The author advances the media work (130) until a desired point is reached. The author then selects the end point (240) corresponding to the end, such as by clicking a “grab ending” icon. When the end scene is grabbed, the ending frame is noted.

The author is further able to move the beginning and ending points (230, 240) along the timeline as desired, to thereby modify the beginning and ending points (230, 240) for the clip (210). For example, the beginning and end points (230, 240) may be displayed visually as points on the timeline (205). These points may be moved by clicking on the beginning and end points (230, 240) and dragging the point along the timeline to advance or reverse the point as desired. Thus, the author is able to select the beginning and ending points (230, 240) while the media is playing, thereby grabbing both the frame number and time of each point separately in order to advance or reverse the points as desired. Thus, the author is able to determine scene length and location. Further, such a configuration allows the author to divide the media work (130), such as a DVD movie, into as many scenes as desired.

Once the parameters of the clip (210) have been selected, the author is then able to choose which repurposing data types to associate or partner with the clip (210). According to one exemplary embodiment, the repurposing data type (220) partnered with the clip (210) includes text. Thus, textual elements may be associated with the scene (200). Such a configuration is optional and may be modified as desired. According to one exemplary embodiment, the default textual element data partnered with the clip (210) is a script (250).

The script (250) may be partnered with the clip (210) by any suitable method. For example, the script (250) may be entered or modified manually, such as by the author, through use of a user input interface such as a keyboard, mouse, joystick, microphone, or any other input interface. The text appears in the output interface (140; FIG. 1). In the case of a motion picture, such a configuration may allow the author to ensure that the script viewed by the student corresponds with the words in the motion picture. Further, the script portion (250) may be acquired from any source, such as from the Internet, a text file, or other source.

Once an author has finished with a scene (200), the author may continue selecting other scenes. The system (100; FIG. 1) allows the author to select the scenes in any order and/or to continue from the ending point of the previous scene. The scenes may then be displayed in any order.

Any number of additional elements can be authored and associated with the scene (200). These elements may include, without limitation, other textual elements, such as vocabulary elements (260), exercises (270), or other types of elements, and/or other media elements, such as explanations, descriptions images, templates, html, tests, recordings, common vocabulary words, conjugations, and/or audio elements. Each element is classified as either a media element or a textual element. The elements in the scene's timeline may be intended (but not required) to be viewed in order by the student. The elements may be inserted into the scene's time line or be displayed simultaneously therewith. For example, textual elements may be displayed simultaneously with the media elements or the elements may be inserted either before or after the media elements, thereby extending the overall duration of a scene. Several exemplary embodiments will now be discussed in more detail. These elements or objects will be broadly discussed as media elements, repurposing elements, or authoring functionality.

Exemplary Elements

As introduced, the system may be configured such that a default media type element is displayed with one or more partnered repurposing elements. The default elements may be referred to as primary objects. The default media object may include a short video scene, such as a DVD scene. The default repurposing object may include a script. Another primary object further partnered with the script may include vocabulary words within the script.

Returning again to FIG. 1, other media and/or repurposing elements may also be provided. These elements, which may be referred to as secondary objects, may be grouped separately. For example, the secondary objects may be placed in a folder called “Explore More” (180). While in player mode (120; FIG. 1) the student will automatically see the first three objects and be able to click on the “Explore More” folder (180) for additional options. When an object or element within the “Explore More” folder (180) is selected, the selected object or element replaces or is shown along side with either the media element or the repurposing element. For example, a textual element selected from the “Explore More” folder (180) may be shown in the second display portion (160). The secondary textual element may replace or be shown with the script in the second display portion (160). While one display configuration is described, those of skill in the art will appreciate that any display configuration is possible.

Observed Media Elements

Returning to FIG. 2, as introduced, according to one exemplary embodiment, each clip represents a portion of an audio/visual work, such as a motion picture residing on a DVD. The content of the scene is defined by the author and can be played at will by the student. Standard DVD navigation buttons are also provided and displayed on the output interface (140; FIG. 1) to allow the student to explore the DVD. The clips or portions selected from a DVD may include clips of a selected duration or individual frames or images captured from the DVD or imported from other sources.

According to one exemplary embodiment, the system provides many of the standard functions for utilizing the content on a DVD. For example, the system allows a viewer to view a selected title linearly, to access chapters, to fast forward, fast reverse, search, access a trailer and/or access additional information that may be available. Other types of media elements may also be repurposed. For example, audio, avi, mpeg, or other types of media files may be repurposed.

The media elements may include HTML elements. The HTML elements may include inline and reference-type elements. Inline HTML elements allow the author to specify actual HTML code that will be rendered and displayed at run time. Reference-type HTML elements allow the author to provide a URL that may be loaded dynamically at run time. This URL can refer to a local file or a location on the Internet.

Referring again to FIG. 1, the system (100) allows the author and/or the student to select how each element/window is displayed. For example, the system (100) may allow the author to determine the relative size of the first display portion (150). In particular, the system allows the author to specify how the media elements are displayed, such as whether the first display portion (150) is stretched, centered, or normal. Repurposing elements are simultaneously displayed with the media elements.

Repurposing Elements

As introduced, the default media element or primary media object may be the script of the selected media work. According to one exemplary embodiment, each scene contains formatted text. The text may be formatted or modified by the author while in author mode (110; FIG. 1). Text formatting options may include setting the font, color, style (bold, italic, normal), and justification of the text. Tabs and bullet points are also available. Vocabulary elements have a title and an associated category. The title and associated category are determined by the author. Each category has a textual name and description. The system may include a predefined set of categories that can be modified or deleted by the author.

Each vocabulary element may be accessed in a number of ways. According to one exemplary method, the system accesses either “glossed words” or simply selects vocabulary elements associated with the clip. These portions of text may include a word or phrase. The author is then able to “gloss” the selected text. Glossing creates an association between the selected portion of text and another element. For example, glossing may create an association or link between the selected text and a vocabulary element and/or scene in a DVD.

When a portion of text is glossed, the glossed text portion appears visually distinct from the surrounding text. For example, the glossed text may be bold where the surrounding text is in plain text format. Similarly, the glossed text may be underlined, highlighted, or differ in color from the surrounding text. When the glossed text is clicked, the associated element is displayed below the glossed text. Each vocabulary element may include specific information related to the selected text. This specific information may include, without limitation, a definition of the word, synonyms, antonyms, or other such information, such as part of speech/sentence or function. Further, such information may include a translation of the glossed text into one or more desired target language and/or a textual and/or audio pronunciation of the glossed text.

In addition to information about each word, the glossed words may be linked to other types of information. For example, clicking on a portion of glossed text may access a text window that explains specific concepts contained in the video. Other types of text windows accessed by clicking on a glossed portion of text may include text windows containing a comparison of speech examples, word study based on scene content, a text window containing cultural explanations, a text window containing a scene summary, grammar explanations on scene language, certain language focus content from a scene, narration of the scene content, and/or character sketches of actors.

Multiple vocabulary elements may be grouped together as a vocabulary list. In particular, the vocabulary list includes a collection of all defined or glossed words in a scene and displays them in alphabetical order. The vocabulary list provides the ability to sort and filter vocabulary elements by name, description, or category type. The vocabulary list has the ability to import vocabulary elements that are contained in other elements, such as text elements or other vocabulary list elements. The system is also able to import word lists from a text file that structures the information in a simple format using tags. This information typically consists of a header, features. Additionally, a list of 53 common verbs in six or more languages may also be displayed as a text object or HTML object for reference.

Vocabulary lists may be generated by the author as desired or may be automatically generated. For example, the system may create vocabulary lists for one or more scenes, for titles, and/or for one or more libraries. This function may be generally referred to as a vocabulary list builder. The vocabulary list builder merges vocabulary lists created by the author, imports vocabulary from script text files, sorts imported lists by category, and/or allows searching of one or more vocabulary words. Thus, the vocabulary list builder may generate vocabulary lists automatically based on author input.

Vocabulary elements, including those included within the script and those within a vocabulary list or otherwise, may be tied to other types of media elements as well. For example, the selected vocabulary element may be tied to an audio element, such as a synthetic speech element that generates an audio reproduction of the selected speech. Further, the selected vocabulary element may be tied to a separate clip.

According to such an embodiment, clicking on the selected vocabulary element may open an associated media file. For example, clicking on the selected vocabulary element may cause the system to access short video clips that illustrate specific language tasks. According to one exemplary embodiment, selecting a vocabulary element related to greetings causes the system to access short clips related to greetings. The short clip may be part of one of the clips previously discussed or the short clip may be part of a portion of a different media work. Further, the short clips may be used to illustrate or explain examples of non-verbal communication.

The present method and system may include additional functionality. For example, in addition to accessing information associated with glossed text selected by the author, the system may be able to access information associated with any portion of the script. This information may include pronunciation information associated with words and as currently available in programs such as Word Point or ABC Word.

Exercises

Exercises are repurposing elements that may also be partnered with a scene from a DVD or other media work in the author mode (110; FIG. 1). Exercise elements are created by the author and are intended to present an interactive exercise to the student. The exercises may be created through a function referred to as an exercise builder. The exercise builder allows the author to select an element and create, select, and/or modify an exercise to be partnered with the selected element to be viewed and used by the player.

The selected element may include a media element. The exercise builder may allow the author to create any number of exercises based on the selected media element within a scene. In particular, according to one exemplary embodiment, the exercise builder allows the author to determine at which point during a scene the exercise is to be presented. For example, the exercise builder allows the author to specify whether the exercise is to be done at the beginning of a scene, during the scene, or at the end of the scene. Further, the exercise builder allows the author to determine if playback of the clip will be paused or suspended while the partnered exercise is being completed.

In general, exercises may be grouped as evaluation-type exercises and self-practice or self-guided type exercises. Evaluation-type exercises include those types of exercises that are to be evaluated and/or scored by an educator, such as the author. Such exercises may include, without limitation, multiple choice, multiple selection, true/false, yes/no, essay, matching, doze (fill in the blank), short answer, or the like. Further, the system allows the author to create any number of evaluation-type exercises as desired.

According to one exemplary embodiment, while in player mode (120), the student is able to view the title or scene and complete the exercises created by the author. For example, in the case of multiple choice, true, false, or other type of objective exercises, the student selects an answer from a plurality of choices. If the exercises include objective questions, the system (100) may be configured to score the objective questions. If the exercises include non-objective questions, such as short answers or essay-type questions, the system collects the student's responses as the student completes the exercises or once the exercises have been completed by the student. The data may be collected to a results folder within the library.

According to one exemplary embodiment, once the exercises are complete, the system (100) transmits the results to the author. For example, the system may be configured to transmit the results to the author via email. Alternatively, the system (100) may be configured to transmit the results to a central server, which may group the results of several students and/or several exercises and then present the collected results to the author. Thus, in addition to providing an author with the ability to create, select, or modify exercises, the system (100) may also automatically score and collect the results of any number of exercises.

The system (100) may be configured to provide further interaction between the student and the author. For example, one of the exercises created by an author with the exercise builder may include a journal exercise. Such an exercise may include spaces or guidance for the student to discuss the film content and to ask questions of the educator. The system then provides these questions to the educator as previously discussed.

In addition to providing interaction through journal exercises, the system (100) may also be configured to provide other types of feedback. For example, one of the exercises created by the exercise builder may include a pronunciation exercise. The pronunciation exercise may include a dialog that prompts the student to view a clip or read a portion of the associated script. Thereafter, the student may be prompted to read the script and/or repeat the dialog in the clip. The system (100) is coupled to a microphone or other audio capturing device to capture and record the student's voice.

According to one exemplary embodiment, the system sends the recording to the author or other educator, as described above. In addition to sending the recording to the author, the recording may also be reviewed by the student. For example, the pronunciation exercise may allow the student to hear the recorded audio, either while the associated clip is replayed or while the associated clip is paused. Thus, the student may be able to compare his or her pronunciation relative to the clip. Consequently, the pronunciation exercise may be both an evaluation-type exercise and a self-guided type exercise.

The exercise builder allows the author to create other types of self-guided exercises. For example, the exercise builder may allow the author to create a concentration exercise. In such an exercise, the student clicks on a square, sees a word written, and hears the word pronounced. The student then clicks on another square to find the matching word. This word will be written differently but rhyme. For example, if “good” was the selected word, the word would be pronounced and a rhyming word, such as “stood” would be displayed along with other words that do not rhyme with the selected word. The exercise builder in author mode (110) also may create exercises involving variants, such as opposites, synonyms, antonyms, etc. Further, the exercise builder may include a crossword puzzler function. Such a function may automatically create crossword puzzles from the associated vocabulary. Once the crossword puzzles are generated, the students may solve the crossword puzzle through player mode.

Additional Functionality

In addition to including vocabulary and exercise elements, the system (100) may include additional repurposing functionality. For example, access to the author mode (110) may be controlled with a login screen, wherein a user is prompted for a login and/or password. The system (100) may include default templates for creating repurposing elements or otherwise. For example, the system may include default or pre-made templates for exercises, vocabulary lists, and general appearance of the scene. Further, the author mode (110) may allow the author to create her own custom scenes from any number of available objects.

Additionally, the system (100) is configured to make use of external data. For example, the system (100) supports data from external sources as desired. The system is also configured to export data. For example, according to one exemplary embodiment, the system (100) may include print support. This print support may allow the author to print lesson plans for use in tutoring or class settings. Further, the system may allow students to print out exercises or other repurposing elements for hard copy study.

In addition to exporting print data, the system (100) may also be configured to export scenes to external devices or storage media. For example, the system may be configured to transmit the scene through S-Video, save the scene to a portable media player, or store the scene to an optical storage medium.

A system and method is described herein for use in language learning and subject-matter content education, such as to teach a foreign or second language and/or any subject-matter content. In particular, according to one exemplary embodiment, a system includes an author mode and a player mode. The author mode allows an educator or other author to annotate and/or repurpose the media content as desired. The media content may include any number of files or clips selected from a media work or from a library. Other repurposing elements may then be added to the time line of the clips including, without limitation, vocabulary lists, exercises, or other learning activities or aids that the author selects and associates with corresponding portions along the time line of the clip. Thus, the system allows an author to repurpose and/or annotate media content.

While in player mode, the present exemplary system allows the repurposed media content programmed by the author to be viewed with a similar appearance as it would be if viewed by a student. In such a mode, the repurposed media content remains in the form designated by the author to be viewed by the student. As such, while in player mode, the repurposed media content is not typically modifiable. The system allows the author to toggle between the author mode and the player mode. Toggling between modes may allow the author to accurately view the content as viewed by a student, and to return to author mode to make any desired adjustments or changes.

The preceding description has been presented only to illustrate and describe exemplary embodiments. It is not intended to be exhaustive or to limit the disclosure to any precise form disclosed. Many modifications and variations are possible in light of the above teaching. It is intended that the scope of the disclosure be defined by the following claims.

What is claimed is:

1. A repurposing system, comprising:
an author mode configured to repurpose a plurality of media elements by partnering at least one repurposing element with at least one media element to form repurposed media content; and
a player mode configured to display said repurposed media content;
said system being configured to allow an authorized user to toggle between said author mode and said player mode while said author is partnering said media element.

2. The system of claim 1, wherein said media elements comprise a portion of a media work.

3. The system of claim 2, wherein said media work comprises at least one of a motion picture, video work, audio work, jpeg, or html content.

4. The system of claim 1, wherein said repurposing element comprises a textual element.

5. The system of claim 4, wherein said textual element comprises at least one of a script, a vocabulary element, a game, commonly used verbs, a translation, a pronunciation, and an exercise.

6. The system of claim 5, wherein said vocabulary element is associated with a selected portion of said script.

7. The system of claim 6, wherein a selecting of said selected portion comprises displaying additional information associated with said vocabulary element.

8. The system of claim 6, wherein said system is configured to generate a vocabulary list based on selected vocabulary elements.

9. The system of claim 1, wherein said repurposing system is configured to send and receive information over a network.

10. The system of claim 9, wherein said network comprises the Internet.

11. The system of claim 1, wherein said system is configured to selectively capture audio.

12. The system of claim 1, wherein said media element comprises a DVD scene.

13. A computer-readable medium having computer-executable instructions to a cause a computer to perform a method comprising:
selectively allowing access to an author mode allowing for selecting at least one media element,
partnering at least one repurposing element with at least one media element to form repurposed content;
selectively viewing said repurposed content in a viewer mode; and
selectively toggling between said viewer mode and said author mode.

14. The computer readable medium of claim 13, wherein said partnering said repurposing element to said media element comprises partnering a textual repurposing element with a media element.

15. The computer readable medium of claim 14, wherein said textual element comprises at least one of a script, a vocabulary element, a game, commonly used verbs, a translation, a pronunciation, and an exercise.

16. The computer readable medium of claim 15, wherein at least one vocabulary element is associated with a selected portion of said script.

17. The computer readable medium of claim 16, wherein selecting said selected portion comprises displaying additional information associated with said vocabulary element.

18. The computer readable medium of claim 16, wherein said system is configured to generate a vocabulary list based on selected vocabulary elements.

19. A system, comprising:
an author mode, including means for selecting at least one media element and means for selecting at least one repurposing element to produce repurposed media content;
a viewer mode for displaying said repurposed media content; and
means for toggling between said author mode and said viewer mode.

20. The system of claim 19, further comprising means for generating a vocabulary list from said repurposing element.
